(19) United States
(12) Patent Application Publication
(10) Pub. No.: US 2026/0112023 A1
(43) Pub. Date: Apr. 23, 2026

(54) DEFECT IMAGE GENERATION

(71) Applicant: Applied Materials, Inc., Santa Clara, CA (US)

(72) Inventors: Shiji Xin, San Jose, CA (US); Hexuan Wang, Fremont, CA (US); Abhinav Kumar, Milpitas, CA (US)

(21) Appl. No.: 19/306,130

(22) Filed: Aug. 21, 2025

Related U.S. Application Data
(60) Provisional application No. 63/710,195, filed on Oct. 22, 2024.

(51) Int. Cl. G06T 7/00; G06F 3/04845; G06V 10/24

(52) U.S. Cl. CPC G06T 7/001; G06F 3/04845; G06V 10/247; G06T 2207/20081; G06T 2207/30148

(57) ABSTRACT

A method includes identifying an output image of a substrate defect based on a user sketch of the substrate defect and a text description associated with the substrate defect. The method further includes updating the output image based on user input to generate an updated output image. The method further includes causing, based on the updated output image, performance of a corrective action associated with substrate processing via a substrate processing system.

### RELATED APPLICATION

This application claims benefit of U.S. Provisional Patent Application No. 63/710,195, filed Oct. 22, 2024, the entire contents of which are incorporated by reference in their entirety.

### TECHNICAL FIELD

The present disclosure relates to defect images, and in particular to defect image generation.

### BACKGROUND

Products are produced by performing one or more manufacturing processes using manufacturing equipment. For example, substrate processing equipment is used to process substrates by transporting substrates to processing chambers and performing processes on the substrates in the processing chambers.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

In an aspect of the disclosure, a method includes identifying an output image of a substrate defect based on a user sketch of the substrate defect and a text description associated with the substrate defect. The method further includes updating the output image based on user input to generate an updated output image. The method further includes causing, based on the updated output image, performance of a corrective action associated with substrate processing via a substrate processing system.

In another aspect of the disclosure, a non-transitory machine-readable storage medium storing instructions which, when executed cause a processing device to perform operations including identifying an output image of a substrate defect based on a user sketch of the substrate defect and a text description associated with the substrate defect. The operations further include updating the output image based on user input to generate an updated output image. The operations further include causing, based on the updated output image, performance of a corrective action associated with substrate processing via a substrate processing system.

In another aspect of the disclosure, a system includes memory and a processing device coupled to the memory. The processing device is to identify an output image of a substrate defect based on a user sketch of the substrate defect and a text description associated with the substrate defect. The processing device is further to update the output image based on user input to generate an updated output image. The processing device is further to cause, based on the updated output image, performance of a corrective action associated with substrate processing via a substrate processing system.

### BRIEF DESCRIPTION OF THE DRAWINGS

The present disclosure is illustrated by way of example, and not by way of limitation in the figures of the accompanying drawings.

FIG. 1 is a block diagram illustrating an exemplary system architecture, according to certain embodiments.

FIGS. 2A-F are block diagrams associated with defect image generation, according to certain embodiments.

FIG. 3 is a graphical user interface associated with defect image generation, according to certain embodiments.

FIGS. 4A-D are flow diagrams of methods associated with defect image generation, according to certain embodiments.

FIG. 5 is a block diagram illustrating a computer system, according to certain embodiments.

### DETAILED DESCRIPTION

Described herein are technologies directed to defect image generation (e.g., systems for generating realistic defect images, enabling faster defect troubleshooting using generative machine learning models, etc.).

Products are produced by performing one or more manufacturing processes using manufacturing equipment. For example, a substrate processing system (e.g., substrate processing equipment, substrate processing tool) in a substrate processing facility is used to process substrates (e.g., wafers, semiconductors, displays, etc.). A substrate processing system may be provided by an equipment manufacturer to a substrate manufacturer. The substrate manufacturer may then use the substrate processing system to generate proprietary substrates. Some of the substrates may have substrate defects (e.g., due to the substrate processing system, due to manufacturing parameters, due to maintenance of the substrate processing system, due to the substrate processing recipe, etc.).

Conventionally the substrate manufacturer does not allow the proprietary images of substrate images to exit the substrate processing facility. If another party, such as the equipment manufacturer, were to see the proprietary images, the other party may have insights on how to perform corrective actions to not make defective substrates. Conventionally, the substrate manufacturer may send a sketch of the proprietary image to the equipment manufacturer or the equipment manufacturer may see the defective substrate at the substrate processing facility and may try to generate a sketch of the defective substrate after leaving the substrate processing facility. In some conventional scenarios, low-quality images (e.g., older images, corrupted images, compressed images) may be available. Conventionally, it is difficult to determine what types of corrective actions to take based on sketches and/or low-quality images. This may cause the substrate processing systems to continue producing defective substrates, cause damage to the substrate processing systems, decrease yield, and/or the like.

The devices, systems, and methods disclosed herein provide solutions to these and other shortcomings of conventional systems.

A processing device may identify an output image of a substrate defect based on a user sketch of the substrate defect and a text description associated with the substrate defect.

In some embodiments, the processing device provides the user sketch and the text description as input to a generative trained machine learning model and receives output associated with the output image from the generative trained machine learning model.

In some embodiments, the input further includes a reference image associated with a reference defect that is similar to the substrate defect.

In some embodiments, the input further includes a matched reference. The processing device may provide the reference image as input to a segmentation trained machine learning model, identify an isolated defect based on output of the segmentation trained machine learning model, perform resizing and rotating of the isolated defect to generate the matched reference.

In some embodiments, the processing device may provide the reference image as an input to a caption trained machine learning model and identify the text description based on output of the caption trained machine learning model.

The processing device may update the output image based on user input to generate an updated output image. In some embodiments, the user input may include selection of a reference image and/or the output image from multiple images.

The processing device may cause, based on the updated output image, performance of a corrective action associated with substrate processing via a substrate processing system. The performance of the corrective action may include processing of a substrate manufacturing part (e.g., preventative maintenance), updating manufacturing parameters, replacing a substrate manufacturing part, redesigning a substrate manufacturing part, and/or the like.

Aspects of the present disclosure result in technological advantages. The present disclosure may generate a more accurate output image of a substrate defect (e.g., based on a sketch or a lower-quality image) than conventional solutions. This may allow the present disclosure to cause performance of a better corrective action than conventional solutions. This may allow the present disclosure to generate less defective substrates, prevent damage to the substrate processing systems, increase yield, and/or the like.

Although some embodiments of the present disclosure are described in relation to generating an output image based on a user sketch and text description, the present disclosure, in some embodiments, may generate an output image based on other information (e.g., low-quality image, etc.).

Although some embodiments of the present disclosure are described in relation to generating an output image of a substrate defect based on a user sketch and text description associated with the substrate defect, the present disclosure, in some embodiments, may generate other types of output images (e.g., associated with a substrate manufacturing part, associated with a substrate without a defect, associated with a product, etc.).

As used herein, the term “produce” can refer to producing a final version of a product (e.g., completely processed substrate) or an intermediary version of a product (e.g., partially processed substrate). As used herein, the producing substrates can refer to processing substrates via performance of one or more substrate processing operations.

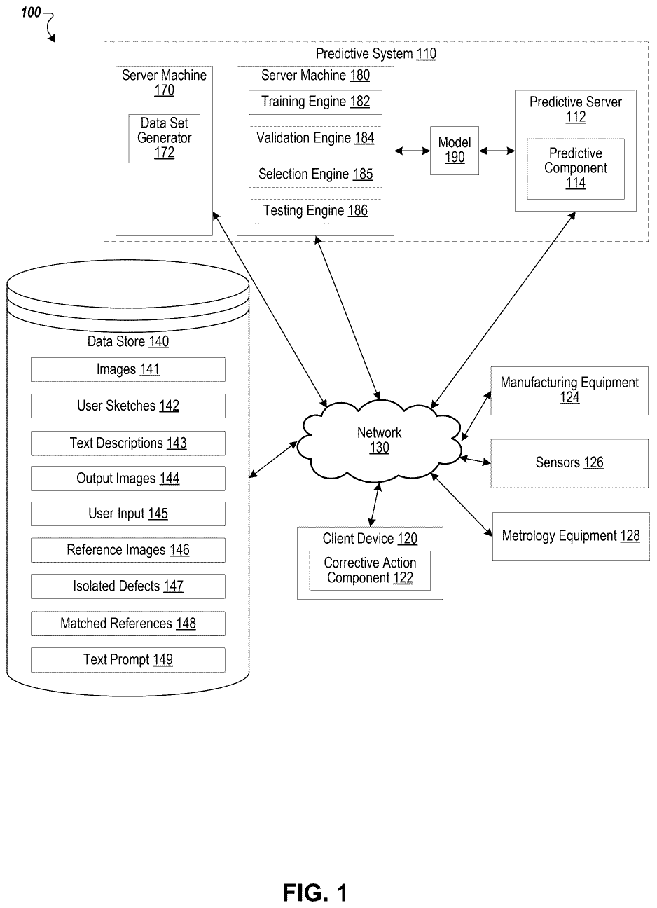

FIG. 1 is a block diagram illustrating an exemplary system 100 (exemplary system architecture), according to certain embodiments. The system 100 includes a client device 120, manufacturing equipment 124 (e.g., a substrate processing system), sensors 126, metrology equipment 128, a predictive server 112, and a data store 140. In some embodiments, the predictive server 112 is part of a predictive system 110. In some embodiments, the predictive system 110 further includes server machines 170 and 180.

In some embodiments, one or more of the client device 120, manufacturing equipment 124, sensors 126, metrology equipment 128, predictive server 112, data store 140, server machine 170, and/or server machine 180 are coupled to each other via a network 130 for causing performance of a corrective action. In some embodiments, network 130 is a public network that provides client device 120 with access to the predictive server 112, data store 140, and other publicly available computing devices. In some embodiments, network 130 is a private network that provides client device 120 access to manufacturing equipment 124, sensors 126, metrology equipment 128, data store 140, and other privately available computing devices. In some embodiments, network 130 includes one or more Wide Area Networks (WANs), Local Area Networks (LANs), wired networks (e.g., Ethernet network), wireless networks (e.g., an 802.11 network or a Wi-Fi network), cellular networks (e.g., a Long Term Evolution (LTE) network), routers, hubs, switches, server computers, cloud computing networks, and/or a combination thereof.

In some embodiments, the client device 120 includes a computing device such as Personal Computers (PCs), laptops, mobile phones, smart phones, tablet computers, netbook computers, etc. In some embodiments, the client device 120 includes a corrective action component 122. In some embodiments, the corrective action component 122 may also be included in the predictive system 110 (e.g., machine learning processing system). In some embodiments, the corrective action component 122 is alternatively included in the predictive system 110 (e.g., instead of being included in client device 120). Client device 120 includes an operating system that allows users to one or more of consolidate, generate, view, or edit data, provide directives to the predictive system 110 (e.g., machine learning processing system), etc.

In some embodiments, corrective action component 122 receives data, such as user sketches 142, text descriptions 143, user input 145, reference images 146, etc. (e.g., from client device 120, from data store 140, via a Graphical User Interface (GUI) displayed via the client device 120). In some embodiments, the corrective action component 122 transmits the data to the predictive system 110, receives predictive data (e.g., output image 144) from the predictive system 110 and causes performance of a corrective action. In some embodiments, the corrective action component 122 stores data in the data store 140 and the predictive server 112 retrieves data from the data store 140. In some embodiments, the predictive server 112 stores output (e.g., predictive data, output images 144) of the trained machine learning model 190 in the data store 140 and the client device 120 retrieves the output from the data store 140. In some embodiments, the corrective action component 122 receives an indication of a corrective action (e.g., based on predictive data, based on output images 144) from the predictive system 110 and causes substrates to be processed based on the corrective action.

In some embodiments, predictive data (e.g., output of model 190) is associated with one or more of an output image 144, text description 143, isolated defects 147, etc. In some embodiments, a corrective action is performed based on the predictive data (e.g., output of model 190). In some embodiments, the performance of a corrective action includes one or more of processing of a substrate manufacturing part (e.g., preventative maintenance), updating manufacturing parameters, replacing a substrate manufacturing part, redesigning a substrate manufacturing part, interrupting operation of one or more portions of a substrate processing system, providing an alert (e.g., an alarm to not use the substrate processing equipment part or the manufacturing equipment 124 if the predictive data indicates a predicted abnormality, etc.), etc.. In some embodiments, the performance of a corrective action includes providing feedback control (e.g., cleaning, repairing, and/or replacing a substrate processing equipment part responsive to the predictive data indicating a predicted abnormality). In some embodiments, the corrective action includes providing machine learning (e.g., determining a predicted component that is to have a fault event based on the predictive data).

In some embodiments, the predictive server 112, server machine 170, and server machine 180 each include one or more computing devices such as a rackmount server, a router computer, a server computer, a personal computer, a mainframe computer, a laptop computer, a tablet computer, a desktop computer, Graphics Processing Unit (GPU), accelerator Application-Specific Integrated Circuit (ASIC) (e.g., Tensor Processing Unit (TPU)), etc.

The predictive server 112 includes a predictive component 114. In some embodiments, the predictive component 114 receives one or more of a user sketch 142, text description 143, reference image 146, matched reference 148, etc. (e.g., receive from the client device 120, retrieve from the data store 140) and generates predictive data (e.g., associated with one or more of an output image 144, text description 143, isolated defect 147, etc.). The predictive data is used to cause performance of a corrective action. In some embodiments, the predictive component 114 uses one or more trained machine learning models 190 to determine the predictive data. In some embodiments, trained machine learning model 190 is trained using input data and/or target output data.

In some embodiments, the predictive system 110 (e.g., predictive server 112, predictive component 114) generates predictive data using supervised machine learning (e.g., supervised data set, input data labeled with target output data, etc.). In some embodiments, the predictive system 110 generates predictive data using semi-supervised learning (e.g., semi-supervised data set, a predictive percentage, etc.). In some embodiments, the predictive system 110 generates predictive data using unsupervised machine learning (e.g., unsupervised data set, clustering, clustering based on historical data, etc.).

In some embodiments, the manufacturing equipment 124 (e.g., cluster tool, a substrate processing system, etc.) is part of a substrate processing system (e.g., integrated processing system). The manufacturing equipment 124 includes one or more of a controller, an enclosure system (e.g., substrate carrier, front opening unified pod (FOUP), auto teach FOUP, process kit enclosure system, substrate enclosure system, cassette, etc.), a side storage pod (SSP), an aligner device (e.g., aligner chamber), a factory interface (e.g., equipment front end module (EFEM)), a load lock, a transfer chamber, one or more processing chambers (e.g., multi-slot processing chambers), a robot arm (e.g., disposed in the transfer chamber, disposed in the front interface, etc.), and/or the like. The enclosure system, SSP, and load lock mount to the factory interface and a robot arm disposed in the factory interface is to transfer content (e.g., substrates, process kit rings, carriers, validation wafer, etc.) between the enclosure system, SSP, load lock, and factory interface. The aligner device is disposed in the factory interface to align the content. The load lock and the processing chambers mount to the transfer chamber and a robot arm disposed in the transfer chamber is to transfer content (e.g., substrates, process kit rings, carriers, validation wafer, etc.) between the load lock, the processing chambers, and the transfer chamber. In some embodiments, the manufacturing equipment 124 includes components of substrate processing systems. In some embodiments, the data include parameters of processes performed by components of the manufacturing equipment 124 (e.g., radio frequency (RF) generation, lifting, etching, heating, cooling, transferring, processing, flowing, cleaning, etc.).

In some embodiments, the sensors 126 provide sensor data (e.g., sensor values, such as historical sensor values and current sensor values) associated with manufacturing equipment 124. In some embodiments, the sensors 126 include one or more of an RF sensor, a lift sensor, an imaging sensor (e.g., camera, image capturing device, etc.), a pressure sensor, a temperature sensor, a flow rate sensor, a spectroscopy sensor, and/or the like. In some embodiments, the sensor data used for equipment health and/or product health (e.g., product quality). In some embodiments, the sensor data is received over a period of time. In some embodiments, sensors 126 provide sensor data such as values of one or more of image data (e.g., images 141, reference images 146, etc.), leak rate, temperature, pressure, flow rate (e.g., gas flow), pumping efficiency, spacing (SP), High Frequency Radio Frequency (HFRF), electrical current, power, voltage, and/or the like. In some embodiments, the images 141 and/or reference images 146 includes sensor data from one or more of sensors 126.

In some embodiments, data is processed by the client device 120 and/or by the predictive server 112. In some embodiments, processing of the data includes generating features. In some embodiments, the features are a portion of the data, processed data, pattern in the data, or a combination of portions of the data. In some embodiments, the data includes features that are used by the predictive component 114 for obtaining predictive data.

In some embodiments, the metrology equipment 128 (e.g., imaging equipment, spectroscopy equipment, ellipsometry equipment, etc.) is used to determine metrology data (e.g., inspection data, image data, spectroscopy data, ellipsometry data, material compositional, optical, or structural data, etc.) corresponding to substrates produced by the manufacturing equipment 124 (e.g., substrate processing equipment). In some examples, after the manufacturing equipment 124 processes substrates, the metrology equipment 128 is used to inspect portions (e.g., layers) of the substrates. In some embodiments, the metrology equipment 128 performs scanning acoustic microscopy (SAM), ultrasonic inspection, x-ray inspection, and/or computed tomography (CT) inspection. In some examples, after the manufacturing equipment 124 deposits one or more layers on a substrate, the metrology equipment 128 is used to determine quality of the processed substrate (e.g., thicknesses of the layers, uniformity of the layers, interlayer spacing of the layer, and/or the like). In some embodiments, the metrology equipment 128 includes an image capturing device (e.g., SAM equipment, ultrasonic equipment, x-ray equipment, CT equipment, and/or the like). In some embodiments, images 141, reference images 146, and/or performance data includes metrology data from metrology equipment 128.

In some embodiments, the data store 140 is memory (e.g., random access memory), a drive (e.g., a hard drive, a flash drive), a database system, or another type of component or device capable of storing data. In some embodiments, data store 140 includes multiple storage components (e.g., multiple drives or multiple databases) that span multiple computing devices (e.g., multiple server computers). In some embodiments, the data store 140 stores one or more of images 141, user sketches 142, text descriptions 143, output images 144, user input 145, reference images 146, isolated defects 147, matched references 148, text prompt 149, etc.

In some embodiments, images 141 are of substrates (e.g., substrate defects of substrates). The substrates may be manufactured by manufacturing equipment 124. The substrates may be partially or completely manufactured.

In some embodiments, user sketches 142 are a visual re-creation of a substrate (e.g., of one or more substrate defects of a substrate). In some embodiments, user sketches 142 are re-created by creating a similar visual representation (e.g., outline, etc.) of the substrate defect by hand via a GUI (e.g. of client device 120) or on a physical medium (e.g., on a piece of paper, on a notepad, etc.). In some embodiments, a user sees an image 141 or a substrate and later re-creates a similar visual representation of the substrate as a user sketch 142. In some embodiments, a user sees an image 141 or a substrate (e.g., proprietary image or proprietary substrate that cannot leave the substrate processing facility) and re-creates a similar visual representation of the image 141 and/or substrate as a user sketch 142 to send outside of the substrate processing facility. In some embodiments, a user sketch 142 is an outline (e.g., hand scribbled defect outline) of a substrate defect.

In some embodiments, text descriptions 143 describe in text (e.g., one or more words, one or more terms) a substrate (e.g., a substrate defect). For example, the text description 143 may include terms such as flake, flake defect, agglomerated, agglomerated defect, flake slightly decorated, bump, recess, etc.

In some embodiments, output images 144 are generated based on input such as one or more of user sketches 142, text descriptions 143, reference images 146, and/or matched references 148. An output image 144 may approximate an image 141 or a substrate defect. An output image 144 may more closely approximate the image 141 or a substrate defect than user sketch 142.

In some embodiments, user input 145 includes a selection of an output image 144, a reference image 146, etc. The user input 145 may be used to update an output image 144. In some embodiments, multiple output images 144 are generated based on a user sketch 142 and text description 143, one of the output images 144 is selected via user input 145, and then one or more updated output images 144 are generated that more closely approximate the selected output image 144. In some embodiments, one or more output images 144 are generated based on a user sketch 142 and text description 143, a reference image 146 is selected via user input 145, and then one or more updated output images 144 are generated that more closely approximate the reference image 146.

In some embodiments, reference images 146 is a historical image of a historical substrate defect. A reference image 146 may be selected that more closely approximates the original image 141 and/or the substrate defect.

In some embodiments, isolated defects 147 may be a portion of the reference image 146 that shows the substrate defect. The isolated defect 147 may be a cropped portion of the reference image 146.

In some embodiments, matched references 148 is an isolated defect 147 of the reference image 146, where the isolated defect 147 has been rotated and/or resized (e.g., zoomed in or zoomed out) to more closely match the user sketch 142.

In some embodiments, text prompt 149 is text that describes a substrate defect and that is used to generate an output image 144 and/or text description 143 (e.g., for generating training data to train model 190).

In some embodiments, historical data includes one or more of the types of data from data store 140 that is associated with historical substrates (e.g., historical substrate defects). The historical data may include historical input data and historical output data. The historical data may be used to train a machine learning model 190.

In some embodiments, current data includes one or more of the types of data from data store 140 that is associated with current substrates (e.g., current substrate defects). The current data may include current input data and/or current output data. The current data may be provided to a trained machine learning model 190 to receive output and/or may be used to re-train a machine learning model 190.

In some embodiments, predictive system 110 further includes server machine 170 and server machine 180. Server machine 170 includes a data set generator 172 that is capable of generating data sets (e.g., a set of data inputs and a set of target outputs) to train, validate, and/or test a machine learning model(s) 190. The data set generator 172 has functions of data gathering, compilation, reduction, and/or partitioning to put the data in a form for machine learning. In some embodiments (e.g., for small datasets), partitioning (e.g., explicit partitioning) for post-training validation is not used. Repeated cross-validation (e.g., 5-fold cross-validation, leave-one-out-cross-validation) may be used during training where a given dataset is in-effect repeatedly partitioned into different training and validation sets during training. A model (e.g., the best model, the model with the highest accuracy, etc.) is chosen from vectors of models over automatically-separated combinatoric subsets.

In some embodiments, the data set generator 172 may explicitly partition the historical data into a training set (e.g., sixty percent of the historical data), a validating set (e.g., twenty percent of the historical data), and a testing set (e.g., twenty percent of the historical data). In some embodiments, the predictive system 110 (e.g., via predictive component 114) generates multiple sets of features (e.g., training features). In some examples a first set of features corresponds to a first set of types of data that correspond to each of the data sets (e.g., training set, validation set, and testing set) and a second set of features correspond to a second set of types of data that correspond to each of the data sets.

Server machine 180 includes a training engine 182, a validation engine 184, selection engine 185, and/or a testing engine 186. In some embodiments, an engine (e.g., training engine 182, a validation engine 184, selection engine 185, and a testing engine 186) refers to hardware (e.g., circuitry, dedicated logic, programmable logic, microcode, processing device, etc.), software (such as instructions run on a processing device, a general-purpose computer system, or a dedicated machine), firmware, microcode, or a combination thereof. The training engine 182 is capable of training a machine learning model 190 using one or more sets of features associated with the training set from data set generator 172. In some embodiments, the training engine 182 generates multiple trained machine learning models 190, where each trained machine learning model 190 corresponds to a distinct set of parameters of the training set (e.g., input data) and corresponding responses (e.g., output data). In some embodiments, multiple models are trained on the same parameters with distinct targets for the purpose of modeling multiple effects. In some examples, a first trained machine learning model was trained using data for all operations (e.g., operations 1-5), a second trained machine learning model was trained using a first subset of the data (e.g., operations 1, 2, and 4), and a third trained machine learning model was trained using a second subset of the data (e.g., operations 1, 3, 4, and 5) that partially overlaps the first subset of features.

The validation engine 184 is capable of validating a trained machine learning model 190 using a corresponding set of features of the validation set from data set generator 172. For example, a first trained machine learning model 190 that was trained using a first set of features of the training set is validated using the first set of features of the validation set. The validation engine 184 determines an accuracy of each of the trained machine learning models 190 based on the corresponding sets of features of the validation set. The validation engine 184 evaluates and flags (e.g., to be discarded) trained machine learning models 190 that have an accuracy that does not meet a threshold accuracy. In some embodiments, the selection engine 185 is capable of selecting one or more trained machine learning models 190 that have an accuracy that meets a threshold accuracy. In some embodiments, the selection engine 185 is capable of selecting the trained machine learning model 190 that has the highest accuracy of the trained machine learning models 190.

The testing engine 186 is capable of testing a trained machine learning model 190 using a corresponding set of features of a testing set from data set generator 172. For example, a first trained machine learning model 190 that was trained using a first set of features of the training set is tested using the first set of features of the testing set. The testing engine 186 determines a trained machine learning model 190 that has the highest accuracy of all of the trained machine learning models based on the testing sets.

In some embodiments, the machine learning model 190 (e.g., used for classification) refers to a model artifact that is created by the training engine 182 using a training set that includes data inputs and corresponding target outputs (e.g., correctly classifies a condition or ordinal level for respective training inputs). Patterns in the data sets can be found that map the data input to the target output (the correct classification or level), and the machine learning model 190 is provided mappings that captures these patterns. In some embodiments, the machine learning model 190 uses one or more of Gaussian Process Regression (GPR), Gaussian Process Classification (GPC), Bayesian Neural Networks, Neural Network Gaussian Processes, Deep Belief Network, Gaussian Mixture Model, or other Probabilistic Learning methods. Non probabilistic methods may also be used including one or more of Support Vector Machine (SVM), Radial Basis Function (RBF), clustering, Nearest Neighbor algorithm (k-NN), linear regression, random forest, neural network (e.g., artificial neural network), etc. In some embodiments, the machine learning model 190 is a multi-variate analysis (MVA) regression model.

Predictive component 114 provides current data (e.g., as input) to the trained machine learning model 190 and runs the trained machine learning model 190 (e.g., on the input to obtain one or more outputs). The predictive component 114 is capable of determining (e.g., extracting) predictive data from the trained machine learning model 190 and determines (e.g., extracts) uncertainty data that indicates a level of credibility that the predictive data corresponds to current data (e.g., output image 144 corresponds to image 141). In some embodiments, the predictive component 114 or corrective action component 122 use the uncertainty data (e.g., uncertainty function or acquisition function derived from uncertainty function) to decide whether to use the predictive data to perform a corrective action (e.g., interrupt operation of one or more components) or whether to further train the model 190.

For purpose of illustration, rather than limitation, aspects of the disclosure describe the training of one or more machine learning models 190 using historical data and providing current data into the one or more trained probabilistic machine learning models 190 to determine predictive data. In other implementations, a heuristic model and/or rule-based model is used to determine predictive data (e.g., without using a trained machine learning model). In other implementations non-probabilistic machine learning models may be used.

In some embodiments, the functions of client device 120, predictive server 112, server machine 170, and server machine 180 are be provided by a fewer number of machines. For example, in some embodiments, server machines 170 and 180 are integrated into a single machine, while in some other embodiments, server machine 170, server machine 180, and predictive server 112 are integrated into a single machine. In some embodiments, client device 120 and predictive server 112 are integrated into a single machine.

In general, functions described in one embodiment as being performed by client device 120, predictive server 112, server machine 170, and server machine 180 can also be performed on predictive server 112 in other embodiments, if appropriate. In addition, the functionality attributed to a particular component can be performed by different or multiple components operating together. For example, in some embodiments, the predictive server 112 determines corrective actions based on the predictive data. In another example, client device 120 determines the predictive data based on data received from the trained machine learning model.

In addition, the functions of a particular component can be performed by different or multiple components operating together. In some embodiments, one or more of the predictive server 112, server machine 170, or server machine 180 are accessed as a service provided to other systems or devices through appropriate application programming interfaces (API).

In some embodiments, a “user” is represented as a single individual. However, other embodiments of the disclosure encompass a “user” being an entity controlled by a plurality of users and/or an automated source. In some examples, a set of individual users federated as a group of administrators is considered a “user.”

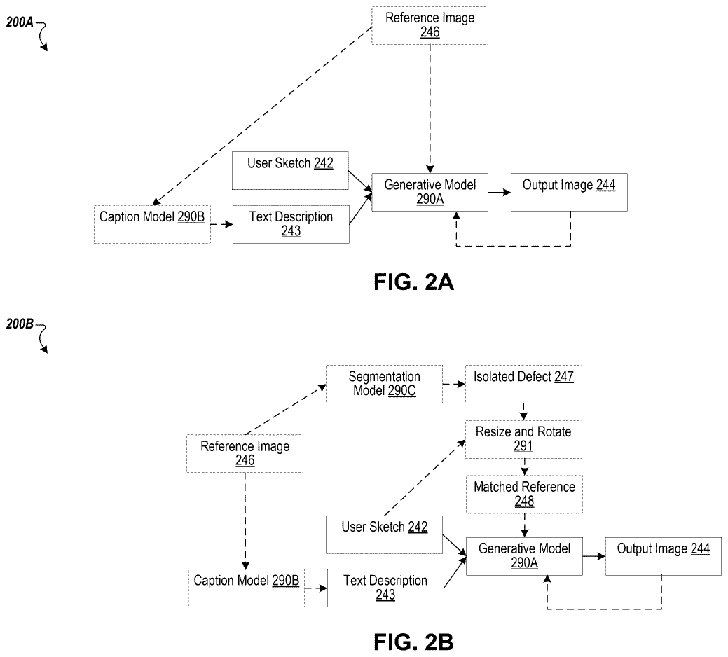

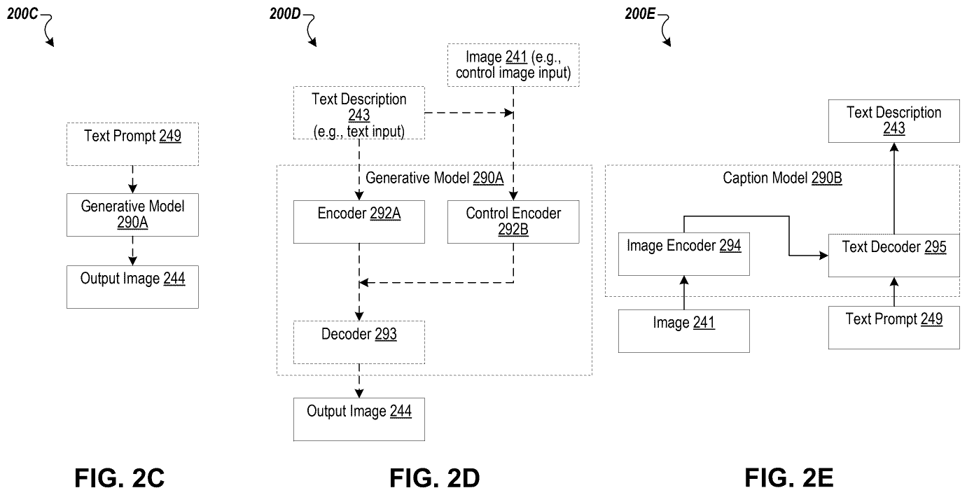

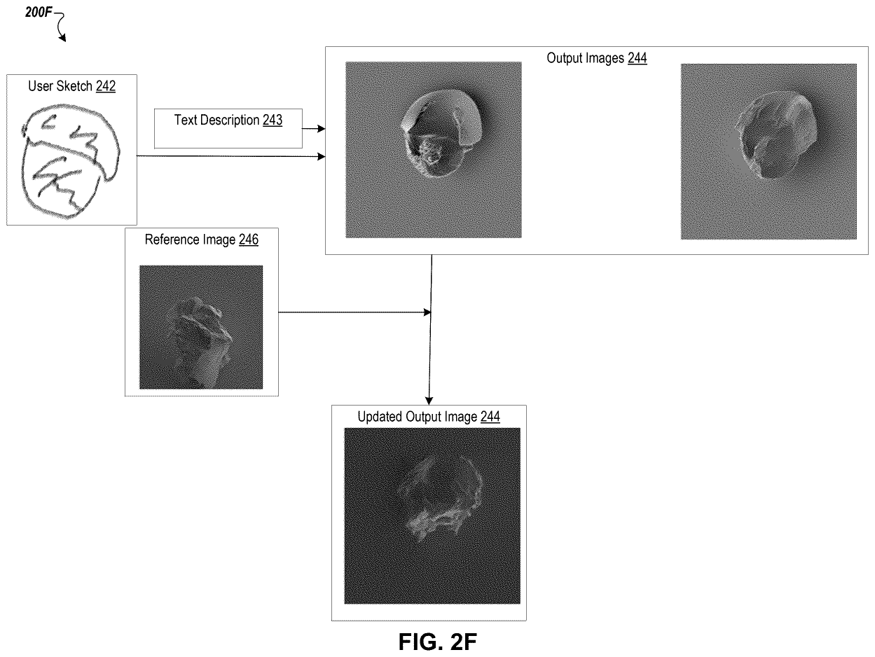

FIGS. 2A-F are block diagrams 200A-F associated with defect image generation, according to certain embodiments.

In some embodiments, in a laboratory (e.g., substrate processing equipment fabrication and/or testing facility), one or more of the following operations may be performed (e.g., by one or more processing devices and/or manually) process development (e.g., developing of a substrate processing recipe), defect excursion (e.g., identifying a substrate that has one or more substrate defects), inspection (e.g., generating metrology data associated with the substrate defects), review (e.g., analyzing the metrology data associated with the substrate defects), classification (e.g., classifying the substrate defects in an image), self-driving defect machine (SDDM) (e.g., software used for root cause identification), and root cause analysis (e.g., why the substrate defects occurred).

In some embodiments, the SDDM and/or root cause analysis are performed outside of a substrate manufacturing facility based on a defect image. An original defect image may be proprietary to the substrate manufacturing facility. Conventionally, SDDM and root cause analysis could not be performed since original defect images were not shared resulting in decreased yield, faulty substrates, less-effective manufacturing parameters, etc.

One or more of FIGS. 2A-F may provide a way to perform SDDM and root cause analysis without sharing a proprietary original defect image (e.g., enables faster defect troubleshooting using generative artificial intelligence (AI) models). In some embodiments, in the field (e.g., substrate manufacturing facility), one or more of the following operations may be performed (e.g., by one or more processing devices and/or manually) process development (e.g., developing of a substrate processing recipe), defect excursion (e.g., identifying a substrate that has one or more substrate defects), inspection (e.g., generating metrology data associated with the substrate defects), review (e.g., analyzing the metrology data associated with the substrate defects), customer showing defects, defect image generation (e.g., generating output image 244 using one or more of FIGS. 2A-F), surface defect detection (SDDM) (e.g., identify and classify defects on the surface of the substrates), and root cause analysis (e.g., why the substrate defects occurred).

One or more of FIGS. 2A-F may be performed using transformer-based image segmentation. This may include a model architecture (e.g., generative AI models, diffusion-based image generation model, generative model 290A, caption model 290B, segmentation model 290C, etc.) that includes three parts: a backbone that extracts low-resolution features; a pixel decoder that upsamples and generates higher-resolution per-pixel embeddings; and a Transformer decoder that processes object queries. The final predictions (e.g., output images 244, updated output images 244) may be decoded from per-pixel embeddings and object queries (e.g., text prompt 249, text description 243, etc.).

One or more of FIGS. 2A-F may perform image generation using diffusion models (e.g., denoising diffusion probabilistic models, model the target distribution through multiple step denoising starting from random noise, generating an output image with high quality and diversity, etc.). One or more of the models (e.g., generative model 290A, etc.) may be trained to generate output images conditioning on text description (e.g., language-conditioned generation). One or more of the models may allow using conditions including one or more of canny edge (e.g., edge detection to detect edges of features in images), pose (e.g., orientation of features in images), depth (e.g., depth of features in images), and scribbles for generation.

Training data can be prepared to train a model (e.g., generative model 290A (e.g., model 190 of FIG. 1, generative AI model). Images 241 may be identified (e.g., collected automatically) and user sketches 242 may be generated based on the images 241 (e.g., via edge detection and/or post-processing). Text description 243 may be generated based on the images 241 (e.g., via hand labeling and/or automatic labeling). In some embodiments, captioning all of the images 241 by hand may be infeasible. The process may be automated via a caption model 290B (e.g., see FIG. 2E, bootstrapping language image pre-training (BLIP) model). The caption model 290B may be used when a user provides an example image (e.g., reference image 246) by assisting users in generating captions for better generation quality.

Referring to block diagram 200A of FIG. 2A, in some embodiments, a user sketch 242 (e.g., user scribble) and a text description 243 (e.g., prompt “flake defect”) are provided (e.g., by processing logic) as input to a generative model 290A (e.g., model 190 of FIG. 1, generative AI model) and the generative model 290A outputs an output image 244 (e.g., a generated defect). The generative model 290A may be used to turn scribbles into realistic defect images. The text description 243 and user sketch 242 may not be accurate and may be difficult for communication and/or analysis of the actual substrate defect without using the generative model 290A.

In some embodiments, the input to generative model 290A further includes a reference image 246.

In some embodiments, the reference image 246 is provided as input to a caption model 290B and the caption model 290B outputs the text description 243. In some embodiments, the text description is provided or selected via user input.

In some embodiments, the generative model 290A outputs two or more output images 244 and at least one output image 244 is selected (e.g., via user input) and is provided as input (e.g., a feedback loop) to the generative model 290A to provide one or more updated output images 244. The one or more updated output images 244 may be based on the selected output image 244.

Referring to block diagram 200B of FIG. 2B, in some embodiments, a user sketch 242 and a text description 243 are provided (e.g., by processing logic) as input to a generative model 290A (e.g., model 190 of FIG. 1) and the generative model 290A outputs an output image 244. The overall outline of the output image 244 and the overall outline of the user sketch 242 may substantially match each other.

In some embodiments, the reference image 246 is provided as input to a caption model 290B and the caption model 290B outputs the text description 243. In some embodiments, the text description is provided or selected via user input.

In some embodiments, the reference image 246 is provided as input to a segmentation model 290C and the segmentation model 290C outputs one or more isolated defects 247 (e.g., cropped reference image 246). Each isolated defect 274 may include one or more substrate defects. The isolated defect 247 is resized and/or rotated 291 (e.g., based on the user sketch 242, to cause the substrate defect in the isolated defect 247 to have substantially the same size and substantially the same orientation as the substrate defect in the user sketch 242) to generate a matched reference 248. The overall outline of the matched reference 248 and the overall outline of the user sketch 242 may substantially match each other. In some embodiments, the input to generative model 290A further includes the matched reference 248 (e.g., the isolated defect 247 of the reference image 246 that has been resized and/or rotated 291 based on the user sketch).

In some embodiments, the generative model 290A outputs two or more output images 244 and at least one output image 244 is selected (e.g., via user input) and is provided as input to the generative model 290A to provide one or more updated output images 244.

Referring to the block diagram 200C of FIG. 2C, a text prompt 249 is provided as input to a generative model 290A and the generative model 290A outputs an output image 244. Generative model 290A may be a text-to-image generative model. Guided by the text prompt 249, the generative model 290A may start with a random input and progressively refine the input into a realistic image by repeatedly applying a series of transformations to move the input closer to a target distribution of real images. In some embodiments, the generative model 290A further receives one or more of a user sketch, 242, a reference image 246, a selected output image 244, a matched reference 248, user input 245, etc. to generate the output image 244 and/or to generate an updated output image 244. The user input 245 may include one or more of a selection of an output image 244 and/or a reference image 246.

Referring to the block diagram 200D of FIG. 2D, an encoder 292A may be a neural network block that may be locked) and a control encoder 292B may be a trainable copy of the encoder 292A.

In some embodiments, a text description 243 (e.g., text input, text prompt 249) is provided as input to encoder 292A and encoder 292A may output an output image 244.

To control the generation of a text to image generation model (e.g., generative model 290A), the parameters of the original model (e.g., encoder 292A) may be frozen, a copy (e.g., control encoder 292B) of the original model may be created with trainable parameters, and an external control (e.g., image 241) may be added to the trainable copy (e.g., control encoder 292B) to train the trainable copy. In some embodiments, the text description 243 (e.g., text input, text prompt 249) and an image 241 (e.g., control image input) is provided as input to control encoder 292B and control encoder 292B may output an output image 244.

By doing this, the original model (e.g., encoder 292A) may remain intact and reliable, while the trainable copy (e.g., control encoder 292B) may learn to adapt to additional controls.

In some embodiments, the output of the encoder 292A and/or control encoder 292B may pass through a decoder 293 to generate the output image 244.

In some embodiments, to train a model (e.g., generative model 290A, caption model 290B, segmentation model 290C), training data may include triplets (e.g., caption, control image, defect image) and the model may be optimized to generate a defect image given the control image and the caption (e.g., text description 243, text prompt 249, etc.). In the training process, part text prompts may be replaced with empty strings. This may increase the ability of the control model to directly recognize semantics in the input conditioning images as replacement for the prompt. For example, instead of providing text and additional text to a text-to-image generation model (e.g., generative model 290A), input including text, an empty string, and an image (e.g., not including the additional text) may be provided as input to a text-to-image generation model (e.g., to use conditional generation) to output an output image 244.

Referring to the block diagram 200E of FIG. 2E, the pretrained image-to-text model (e.g., caption model 290B) may be finetuned for captioning defect images. In some embodiments, an image 241 may be provided to an image encoder 294 which provides output to a text decoder 295. The text decoder 295 further receives a text prompt 249 (e.g., prompt of “a gray scale microscopic image of X”) and the text decoder 295 outputs a text description 243 (e.g., caption).

Referring to the block diagram 200F of FIG. 2F, in some embodiments, a user sketch 242 and a text description 243 are used (e.g., by generative model 290A) to generate output images 244. A reference image 246 may be used (e.g., by generative model 290A) in addition to one or more of the output images 244 to generate an updated image 244 that more closely approximates the original image than the output images 244.

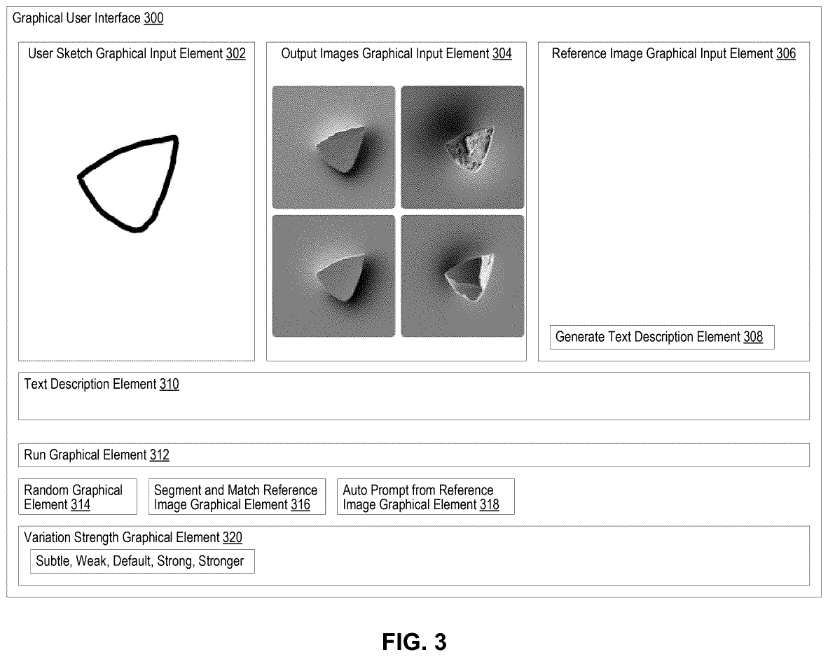

FIG. 3 is a graphical user interface (GUI) 300 associated with defect image generation, according to certain embodiments.

Conventionally, a defect image or substrate defect may be shown to a user (e.g., inside a customer substrate fabrication facility and the user is to use their memory of the defect image or substrate defect after leaving the substrate fabrication facility to attempt to perform a corrective action (e.g., improve the manufacturing parameters, improve the substrate processing equipment, etc.). It may be difficult to describe defects observed at a restricted customer location. Conventionally, a user sketch of a substrate defect may be provided to attempt to perform a corrective action (e.g., improve the manufacturing parameters, improve the substrate processing equipment, etc.). Conventionally, one or more low-quality substrate defect images may be provided to perform a corrective action (e.g., improve the manufacturing parameters, improve the substrate processing equipment, etc.).

Generative AI (e.g., model 190 of FIG. 1, model 290 of one or more of FIGS. 2A-F, multimodal generative AI model) may be used for defect troubleshooting (e.g., defect image generation). Generative AI may be used to generate similar looking defect images from scribbles (e.g., user sketch 242) and text prompts (e.g., text description 243). Generated images (e.g., output images 244) may be provided to a SDDM to perform root cause identification. This may enable faster defect troubleshooting by providing hardware overlay, parts, and partition plans.

The GUI 300 may include a user sketch graphical input element 302. Via the user sketch graphical input element 302, a user sketch (e.g., user sketch 142 of FIG. 1, hand-scribbled defect outline, defect drawing) may be generated (e.g., sketched or scribbled via user input) or uploaded (e.g., a scan or previous drawing of a user sketch may be uploaded).

The GUI 300 may include a output images graphical input element 304. GUI 300 may display one or more output images (e.g., output images 144 of FIG. 1) based on data received via GUI 300 (e.g., user sketch, text description, reference image, selection of an output image, etc.). The output images graphical input element 304 may allow user selection of one or more of the output images for re-generation of output images that more closely approximate the selected output image. In some embodiments, the output images graphical input element 304 may display a generated defect and root cause prediction. An output image can be selected via output images graphical input element 304 and may be saved (e.g., to the computing device that is displaying the GUI 300, to another device via the network, etc.). The selected output image may be used to perform a corrective action.

The GUI 300 may include a reference image graphical input element 306. Via the reference image graphical input element 306, a reference image (e.g., reference image 146 of FIG. 1) may be uploaded an/or selected.

The GUI 300 may include a generate text description element 308. By selecting the generate text description element 308, a text description (e.g., text description 143 of FIG. 1, text prompt describing defect) may be generated based on the reference image associated with the reference image graphical input element 306. In some embodiments, the text description is flake, large flake, bump, agglomerated, etc.

The GUI 300 may include a text description element 310. Via the text description element 310, a text description (e.g., text description 143 of FIG. 1) may be input or selected. Responsive to selection of the text description element 308, text description element 310 may display a text description based on the reference image associated with the reference image graphical input element 306 (e.g., a text description associated with a label of the reference image).

The GUI 300 may include a run graphical element 312. Responsive to selection of the run graphical element 312, one or more output images may be displayed via the output images graphical input element 304 based one or more of the user sketch associated with user sketch graphical input element 302, a selection of one or more output images via the output images graphical input element 304, a reference image associated with the reference image graphical input element 306, a text description associated with the generate text description element 308 and/or the text description element 310.

The GUI 300 may include a random graphical element 314. Responsive to selection of the random graphical element 314, the output images associated with output images graphical input element 304 may be randomly generated (e.g., based on user sketch associated with user sketch graphical input element 302 and text description associated with the generate text description element 308 and/or the text description element 310).

The GUI 300 may include a segment and match reference image graphical element 316. Responsive to selection of the segment and match reference image graphical element 316, the reference image associated with reference image graphical input element 306 may be segmented and matched (e.g., via segmentation model 290C and resize and rotate 291 of FIG. 2B) to the user sketch associated with the user sketch graphical input element 302 and the output images associated with output images graphical input element 304 may be generated based on the segmented and matched reference image (e.g., based on user sketch associated with user sketch graphical input element 302 and text description associated with the generate text description element 308 and/or the text description element 310).

The GUI 300 may include an auto prompt from reference image graphical element 318. Responsive to selection of the auto prompt from reference image graphical element 318, the text description of text description element 310 may be automatically generated based on the reference image associated with reference image graphical input element 306.

The GUI 300 may include a variation strength graphical element 320. Via the variation strength graphical element 320, selection of how close the output images associated with the output images graphical input element 304 are to approximate the user input (e.g., user sketch associated with user sketch graphical input element 302, selected output images associated with the output images graphical input element 304, reference image associated with reference image graphical input element 306, text description associated with the generate text description element 308 and/or text description element 310, etc.) and/or other output images associated with the output images graphical input element 304. Variation strength graphical element 320 may allow user selection of subtle, weak, default, strong, stronger, and/or the like to allow differing levels of variation (e.g., how closely the output images approximate user input and/or each other).

In some embodiments, GUI 300 receives user input (e.g., one or more of random graphical element 314, segment and match reference image graphical element 316, auto prompt from reference image graphical element 318, and/or variation strength graphical element 320 are selected, a text description is entered via text description element 310, a user sketch is input via the user sketch graphical input element 302), run graphical element 312 is selected via GUI 300, and output images are generated and displayed via output images graphical input element 304.

In some embodiments, the text description is updated via text description element 310, the run graphical element 312 is selected, and updated output images (e.g., an update to the output images previously displayed) are generated and displayed via output images graphical input element 304.

In some embodiments, the user sketch is updated via user sketch graphical input element 302, the run graphical element 312 is selected, and updated output images (e.g., an update to the output images previously displayed) are generated and displayed via output images graphical input element 304.

In some embodiments, an output image associated with the output images graphical input element 304 is selected (e.g., an output image that most closely approximates the original substrate defect image is dragged and dropped into the reference image graphical input element 306), the run graphical element 312 is selected, and updated output images (e.g., an update to the output images previously displayed) are generated and displayed via output images graphical input element 304.

In some embodiments, a reference image is selected via the reference image graphical input element 306 (e.g., is selected from memory of the computing device that is displaying the GUI 300, is selected from the network), the run graphical element 312 is selected, and updated output images (e.g., an update to the output images previously displayed) are generated and displayed via output images graphical input element 304.

The GUI can be used to generate output images based on user input and to generate updated output images (e.g., updating of the original output images) based on further user input.

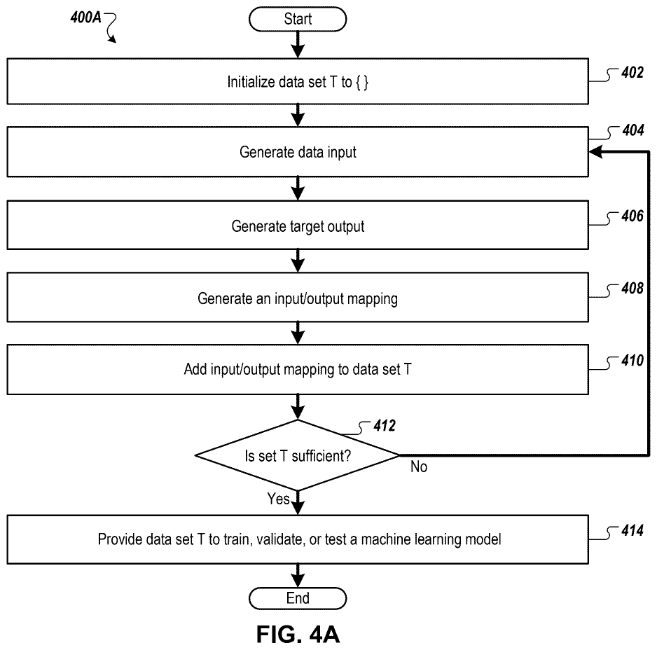

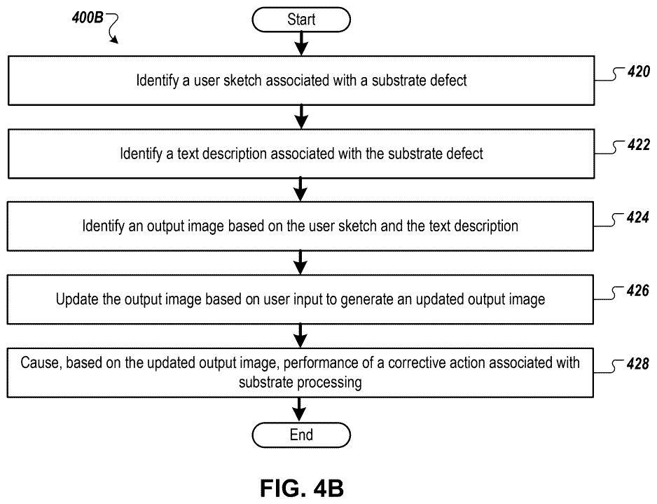

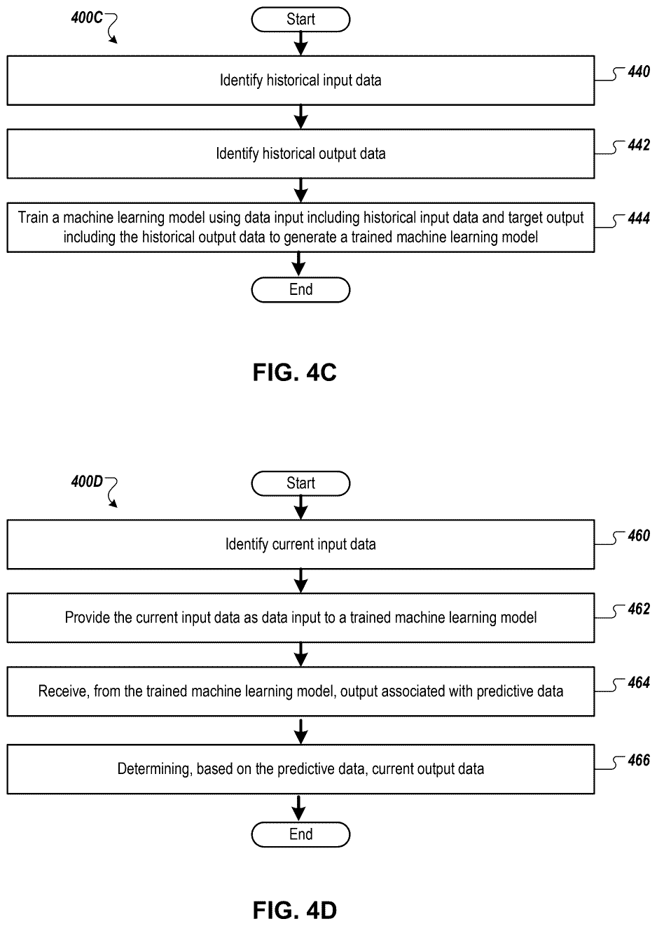

FIGS. 4A-D are flow diagrams of methods 400A-D associated with defect image generation, according to certain embodiments. In some embodiments, methods 400A-D are performed by processing logic that includes hardware (e.g., circuitry, dedicated logic, programmable logic, microcode, processing device, etc.), software (such as instructions run on a processing device, a general-purpose computer system, or a dedicated machine), firmware, microcode, or a combination thereof. In some embodiments, methods 400A-D are performed, at least in part, by predictive system 110 and/or client device 120. In some embodiments, method 400A is performed, at least in part, by predictive system 110 (e.g., server machine 170 and data set generator 172 of FIG. 1). In some embodiments, predictive system 110 uses method 400A to generate a data set to at least one of train, validate, or test a machine learning model. In some embodiments, method 400B is performed by client device 120 (e.g., corrective action component 122). In some embodiments, method 400C is performed by server machine 180 (e.g., training engine 182, etc.). In some embodiments, method 400D is performed by predictive server 112 (e.g., predictive component 114). In some embodiments, a non-transitory storage medium stores instructions that when executed by a processing device (e.g., of predictive system 110, of server machine 180, of predictive server 112, etc.), cause the processing device to perform one or more of methods 400A-D.

For simplicity of explanation, methods 400A-D are depicted and described as a series of operations. However, operations in accordance with this disclosure can occur in various orders and/or concurrently and with other operations not presented and described herein. Furthermore, in some embodiments, not all illustrated operations are performed to implement methods 400A-D in accordance with the disclosed subject matter. In addition, those skilled in the art will understand and appreciate that methods 400A-D could alternatively be represented as a series of interrelated states via a state diagram or events.

In some embodiments, one or more of methods 400A-D generates realistic defect images to enable faster defect troubleshooting using generative AI models than conventional solutions. One or more of methods 400A-D may be an AI-powered tool that empowers field engineers to create realistic defect images by sketching and describing the issue. This may eliminate manual image capturing which may make defect generation process accurate and efficient. This may bridge the gap between field engineers and the existing workflow, enabling corrective actions, such as defect root cause analysis.

Conventionally, field engineers are unable to capture and document defect images in customer sites where a strict intellectual property (IP) rule is enforced. One or more of methods 400A-B allow field engineers to create and draw defect images that mimic real defects which may allow field engineers to be integrated into the whole defect diagnosis workflow with downstream applications (e.g., corrective actions) including morphology analysis, defect classification, and root cause analysis.

Conventionally, rough sketches and brief descriptions are logged which are not useful in performing corrective actions. One or more of methods 400A-E may generate realistic images that more precisely mimic the actual defect than conventional solutions. This may reduce or eliminate the potential for misinterpretation that can occur during communication when relying on verbal descriptions or simple drawings. One or more of methods 400A-E may include a feedback loop that allows for continuous improvement and refinement of the generated output image (e.g., generated defect image, updated output images 244 are based on a selected output image 244).

The present disclosure may include quick and accurate generation of output images (e.g., of substrate images) which reduces misunderstandings and errors during communication. The present disclosure may enable downstream analysis (e.g., corrective actions) that uses realistic images, allowing applications such as defect classification and root cause analysis. This may shorten the defect diagnostic cycle. The present disclosure may allow process engineers to respond quickly to defects, thereby improving the efficiency of the team.

The present disclosure may include a generative model 290A that produces a defect image based on user-provided scribble (e.g., user sketch 242) and text-based defect description (e.g., text description 243). The user can provide feedback by either selecting an output image 244 (e.g., a preferred generated image) or uploading a reference image 246. By leveraging additional deep learning models, the present disclosure may transfer the defect morphology of the reference images 246 to the generated output image 244. Natural language processing models (e.g., caption model 290B) may be used to generate image descriptions (e.g., text description 243) from the reference image 246.

The present disclosure may be used with wafer defects, substrate defects, semiconductor defects, scanning electron microscope (SEM) images, image generation, computer vision, etc.

FIG. 4A is a flow diagram of a method 400A for generating a data set for a machine learning model associated with defect image generation, according to certain embodiments.

Referring to FIG. 4A, in some embodiments, at block 402 the processing logic implementing method 400A initializes a training set T to an empty set.

At block 404, processing logic generates first data input (e.g., first training input, first validating input) that includes historical input data. In some embodiments, the first data input includes a first set of features for types of data and a second data input includes a second set of features for types of data.

At block 406, processing logic generates a first target output for one or more of the data inputs (e.g., first data input). In some embodiments, the first target output is historical output data.

In some embodiments, for a generative model 290A, the historical input data includes historical user sketches 242 and historical text descriptions 243 and the historical output data includes historical output images 244. In some embodiments, for a generative model 290A, the historical output data includes images 241 and the historical input data includes user sketches 242 generated based on the images 241 and text descriptions 243 generated based on the images 241.

In some embodiments, for a caption model 290B, the historical input data includes images 241 and/or text prompts 249 and the historical output includes historical text descriptions 243 (e.g., see FIG. 2E).

In some embodiments, for a segmentation model 290C, the historical input data includes historical reference images 246 and the historical output data includes historical isolated defects 247.

At block 408, processing logic optionally generates mapping data that is indicative of an input/output mapping. The input/output mapping (or mapping data) refers to the data input (e.g., one or more of the data inputs described herein), the target output for the data input (e.g., where the target output identifies historical performance data 154), and an association between the data input(s) and the target output.

At block 410, processing logic adds the mapping data generated at block 408 to data set T.

At block 412, processing logic branches based on whether data set T is sufficient for at least one of training, validating, and/or testing machine learning model 190 (e.g., uncertainty of the trained machine learning model meets a threshold uncertainty). If so, execution proceeds to block 414, otherwise, execution continues back to block 404. It should be noted that in some embodiments, the sufficiency of data set T is determined based simply on the number of input/output mappings in the data set, while in some other implementations, the sufficiency of data set T is determined based on one or more other criteria (e.g., a measure of diversity of the data examples, accuracy, etc.) in addition to, or instead of, the number of input/output mappings.

At block 414, processing logic provides data set T (e.g., to server machine 180) to train, validate, and/or test machine learning model 190. In some embodiments, data set T is a training set and is provided to training engine 182 of server machine 180 to perform the training. In some embodiments, data set T is a validation set and is provided to validation engine 184 of server machine 180 to perform the validating. In some embodiments, data set T is a testing set and is provided to testing engine 186 of server machine 180 to perform the testing. In the case of a neural network, for example, input values of a given input/output mapping (e.g., numerical values associated with data inputs 210) are input to the neural network, and output values (e.g., numerical values associated with target outputs 220) of the input/output mapping are stored in the output nodes of the neural network. The connection weights in the neural network are then adjusted in accordance with a learning algorithm (e.g., back propagation, etc.), and the procedure is repeated for the other input/output mappings in data set T.

After block 414, machine learning model (e.g., machine learning model 190) can be at least one of trained using training engine 182 of server machine 180, validated using validating engine 184 of server machine 180, or tested using testing engine 186 of server machine 180. The trained machine learning model is implemented by predictive component 114 (of predictive server 112) to generate predictive data (e.g., predictive data) for fault event recovery in multi-slot processing chambers (e.g., cause performance of a corrective action, etc.).

FIG. 4B is a method 400B associated with defect image generation, according to certain embodiments.

At block 420 of method 400B, the processing logic identifies a user sketch associated with a substrate defect.

At block 422, the processing logic identifies a text description associated with the substrate defect.

In some embodiments, the user sketch and/or text description are input via a GUI (e.g., GUI 300 of FIG. 3).

In some embodiments, the processing logic identifies a reference image associated with a reference defect that is similar to the substrate defect, provides the reference image as corresponding input to a caption trained machine learning model (e.g., caption model 290B), and receives, from the caption trained machine learning model, output associated with the text description.

At block 424, the processing logic identifies an output image (e.g., of the substrate defect) based on the user sketch and the text description.

In some embodiments, the processing logic provides input including the user sketch and the text description to a generative trained machine learning model (e.g., generative model 290A), wherein the output image is associated with output from the generative trained machine learning model. In some embodiments, the input further includes a reference image associated with a reference defect that is similar to the substrate defect.

In some embodiments, the processing logic identifies a reference image associated with a reference defect that is similar to the substrate defect, provides the reference image as corresponding input to a segmentation trained machine learning model (e.g., segmentation model 290C), receives, from the segmentation trained machine learning model, corresponding output associated with an isolated defect, and performs, based on the user sketch, resizing and rotating of the isolated defect to generate a matched reference. The input may further include the matched reference.

At block 426, the processing logic updates the output image based on user input to generate an updated output image. The updated output image is based on the output image identified in block 424. In some embodiments, the user input includes selection of one or more of a reference image or the output image from multiple images. In some embodiments, the user input includes updates to the user sketch and/or updates to the text description. In some embodiments, the user input is associated with a variation strength (e.g., subtle, weak, default, strong, stronger) associated with how closely the output images match each other, a reference image, a user sketch, and/or the text description.

At block 428, the processing logic causes, based on the updated output image (e.g., of block 426), performance of a corrective action associated with substrate processing via a substrate processing system. In some embodiments, at block 428, the processing logic provides the updated output image (e.g., of block 426) as input to a SDDM and receives an output from the SDDM associated with performance of a corrective action.

In some embodiments, at block 428, the processing logic causes, based on the output image (e.g., of block 424), performance of a corrective action associated with substrate processing via a substrate processing system.

In some embodiments, at block 428, the processing logic causes, based on the user sketch (e.g., of block 420) and/or the text description (e.g., of block 422), performance of a corrective action associated with substrate processing via a substrate processing system.

In some embodiments, the causing of the performance of the corrective action includes one or more of: processing (e.g., preventive maintenance, cleaning, removal of a residue, etc.) of a substrate manufacturing part; updating manufacturing parameters (e.g., updating temperature); replacing of the substrate manufacturing part; or redesigning the substrate manufacturing part (e.g., updating the hole pattern in a showerhead part, updating alignment of holes in a showerhead part, etc.).

In some embodiments, the processing logic determines a type of substrate defect based on the updated output image and causes performance of the corrective action based on the type of substrate defect.

In some embodiments, the performance of the corrective action includes performing a root cause analysis (e.g., determining why the substrate defect occurred and/or how to prevent the substrate defect in future substrates). In some examples, the root cause analysis is used to determine that a design of a substrate manufacturing part caused the substrate defect associated with the updated output image and/or an updated design of the substrate manufacturing part avoids production of substrates that have the substrate defect associated with the updated output image.

In some embodiments, the performance of the corrective action includes using the updated output images to design a substrate manufacturing part that avoids producing the substrate defect in future substrates.

In some embodiments, at block 426, the processing logic uses the updated output image to identify a corrective action from a database (e.g., identifies the type of substrate defect and identifies a corrective action from the database based on the type of substrate defect).

In some embodiments, the updated output image is used to troubleshoot the substrate processing. In some embodiments, a database links defect images to possible group causes (e.g., type of coating, part design, shower head design, etc.) that may cause the substrate to form. The updated output image may be used to determine a cause of why the substrate defect formed.

In some embodiments, a database includes corrective actions associated with substrate defect images. The processing logic may find a corresponding corrective action from the database based on the updated output image.

FIG. 4C is a method 400C for training a machine learning model (e.g., model 190 of FIG. 1) associated with defect image generation.

Referring to FIG. 4C, at block 440 of method 400C, the processing logic identifies historical input data.

At block 442, the processing logic identifies historical output data.

In some embodiments, for a generative model 290A, the historical input data includes historical user sketches 242 and historical text descriptions 243 and the historical output data includes historical output images 244. In some embodiments, for a generative model 290A, the historical output data includes images 241 and the historical input data includes user sketches 242 generated based on the images 241 and text descriptions 243 generated based on the images 241.

In some embodiments, for a caption model 290B, the historical input data includes images 241 and/or text prompts 249 and the historical output includes historical text descriptions 243 (e.g., see FIG. 2E).

In some embodiments, for a segmentation model 290C, the historical input data includes historical reference images 246 and the historical output data includes historical isolated defects 247.

At block 444, the processing logic trains a machine learning model using data input including historical input data and target output including the historical output data to generate a trained machine learning model. The performance of a corrective action (e.g., of block 428 of FIG. 4B) may be by using the trained machine learning model of FIG. 4C. In some embodiments, the trained machine learning model is a neural network.

FIG. 4D is a method 400D for using a trained machine learning model (e.g., model 190 of FIG. 1) associated with defect image generation. FIG. 4D may be used for block 422 of FIG. 4B (e.g., caption model 290B) and/or for block 424 and/or block 426 of FIG. 4B (e.g., generative model 290A and/or segmentation model 290C).

Referring to FIG. 4D, at block 460 of method 400D, the processing logic identifies current input data.

At block 462, the processing logic provides the current input data as data input to a trained machine learning model (e.g., trained via block 444 of FIG. 4C).

At block 464, the processing logic receives, from the trained machine learning model, output associated with predictive data.

At block 466, the processing logic determines, based on the predictive data, current output data.

In some embodiments, for a generative model 290A, the current input data includes one or more of a user sketch 242, text description 243, reference image 246, a selected output image 244, etc. and the current output data includes an output image 244 or an updated output image.

In some embodiments, for a caption model 290B, the current input data includes a reference image 246 and the current output data includes a text description 243.

In some embodiments, for a segmentation model 290C, the current input data includes a reference image 246 and the current output data includes an isolated defect 247 (e.g., portion of the reference image 246).

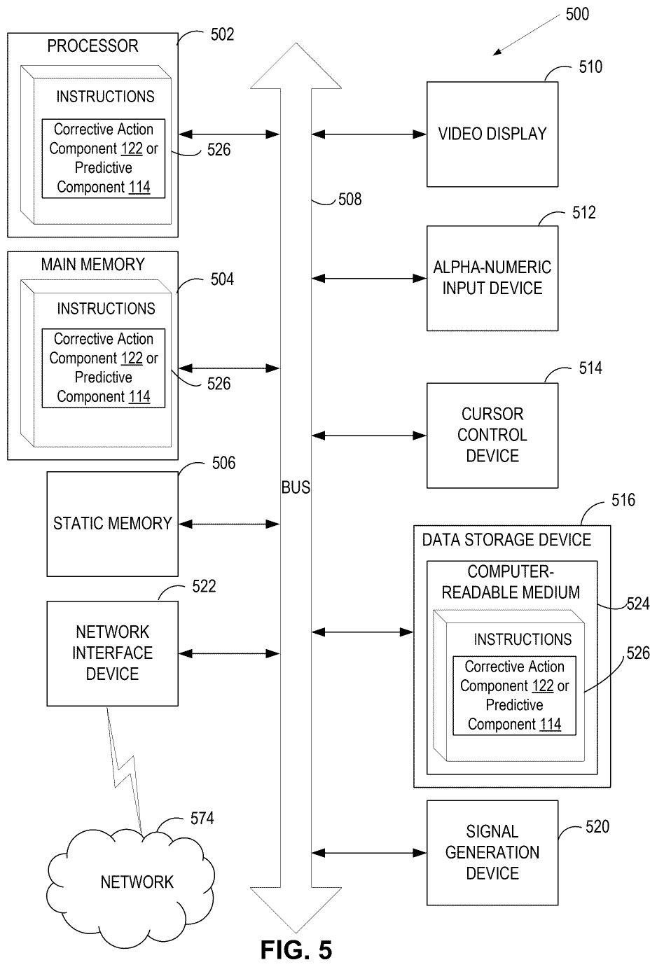

FIG. 5 is a block diagram illustrating a computer system 500, according to certain embodiments. In some embodiments, the computer system 500 is one or more of client device 120, predictive system 110, server machine 170, server machine 180, or predictive server 112.

In some embodiments, computer system 500 is connected (e.g., via a network, such as a Local Area Network (LAN), an intranet, an extranet, or the Internet) to other computer systems. In some embodiments, computer system 500 operates in the capacity of a server or a client computer in a client-server environment, or as a peer computer in a peer-to-peer or distributed network environment. In some embodiments, computer system 500 is provided by a personal computer (PC), a tablet PC, a Set-Top Box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 500 includes a processing device 502, a volatile memory 504 (e.g., Random Access Memory (RAM)), a non-volatile memory 506 (e.g., Read-Only Memory (ROM) or Electrically Erasable Programmable ROM (EEPROM)), and a data storage device 516, which communicate with each other via a bus 508.

In some embodiments, processing device 502 is provided by one or more processors such as a general purpose processor (such as, for example, a Complex Instruction Set Computing (CISC) microprocessor, a Reduced Instruction Set Computing (RISC) microprocessor, a Very Long Instruction Word (VLIW) microprocessor, a microprocessor implementing other types of instruction sets, or a microprocessor implementing a combination of types of instruction sets) or a specialized processor (such as, for example, an Application Specific Integrated Circuit (ASIC), a Field Programmable Gate Array (FPGA), a Digital Signal Processor (DSP), or a network processor).

In some embodiments, computer system 500 further includes a network interface device 522 (e.g., coupled to network 574). In some embodiments, computer system 500 also includes a video display unit 510 (e.g., a liquid crystal display (LCD)), an alphanumeric input device 512 (e.g., a keyboard), a cursor control device 514 (e.g., a mouse), and a signal generation device 520.

In some implementations, data storage device 516 includes a non-transitory computer-readable storage medium 524 on which store instructions 526 encoding any one or more of the methods or functions described herein, including instructions encoding components of FIG. 1 (e.g., corrective action component 122, predictive component 114, etc.) and for implementing methods described herein.

In some embodiments, instructions 526 also reside, completely or partially, within volatile memory 504 and/or within processing device 502 during execution thereof by computer system 500, hence, in some embodiments, volatile memory 504 and processing device 502 also constitute machine-readable storage media.

While computer-readable storage medium 524 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

In some embodiments, the methods, components, and features described herein are implemented by discrete hardware components or are integrated in the functionality of other hardware components such as application-specific integrated circuits (ASICs), field programmable gate arrays (FPGAs), digital signal processors (DSPs), or similar devices. In some embodiments, the methods, components, and features are implemented by firmware modules or functional circuitry within hardware devices. In some embodiments, the methods, components, and features are implemented in any combination of hardware devices and computer program components, or in computer programs.

Unless specifically stated otherwise, terms such as “identifying,” “updating,” “causing,” “providing,” “receiving,” “performing,” “processing,” “replacing,” “redesigning,” “determining,” “running,” “continuing,” “interrupting,” “initiating,” “returning,” “dechucking,” “flowing,” “training,” “obtaining,” “outputting,” “predicting,” “receiving,” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. In some embodiments, the terms “first,” “second,” “third,” “fourth,” etc. as used herein are meant as labels to distinguish among different elements and do not have an ordinal meaning according to their numerical designation.

Examples described herein also relate to an apparatus for performing the methods described herein. In some embodiments, this apparatus is specially constructed for performing the methods described herein, or includes a general-purpose computer system selectively programmed by a computer program stored in the computer system. Such a computer program is stored in a computer-readable tangible storage medium.

The methods and illustrative examples described herein are not inherently related to any particular computer or other apparatus. In some embodiments, various general-purpose systems are used in accordance with the teachings described herein. In some embodiments, a more specialized apparatus is constructed to perform methods described herein and/or each of their individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

1. A method comprising:
identifying an output image of a substrate defect based on a user sketch of the substrate defect and a text description associated with the substrate defect;
updating the output image based on a user input to generate an updated output image; and
causing, based on the updated output image, performance of a corrective action associated with substrate processing via a substrate processing system.

2. The method of claim 1 further comprising:
identifying the user sketch of the substrate defect;
identifying the text description associated with the substrate defect; and
providing input comprising the user sketch and the text description to a generative trained machine learning model, wherein the output image is associated with output from the generative trained machine learning model.

3. The method of claim 2, wherein the input further comprises a reference image associated with a reference defect that is similar to the substrate defect.

4. The method of claim 2 further comprising:
identifying a reference image associated with a reference defect that is similar to the substrate defect;
providing the reference image as corresponding input to a segmentation trained machine learning model;
receiving, from the segmentation trained machine learning model, corresponding output associated with an isolated defect; and
performing, based on the user sketch, resizing and rotating of the isolated defect to generate a matched reference, wherein the input further comprises the matched reference.

5. The method of claim 1 further comprising:
identifying a reference image associated with a reference defect that is similar to the substrate defect;
providing the reference image as corresponding input to a caption trained machine learning model; and
receiving, from the caption trained machine learning model, output associated with the text description.

6. The method of claim 1, wherein the user input comprises selection of one or more of a reference image or the output image from a plurality of images.

7. The method of claim 1, wherein the causing of the performance of the corrective action comprises one or more of:
processing of a substrate manufacturing part of the substrate processing system;
updating manufacturing parameters of the substrate processing system;
replacing of the substrate manufacturing part of the substrate processing system; or
redesigning the substrate manufacturing part of the substrate processing system.

8. The method of claim 1, wherein the substrate defect is of a substrate processed by the substrate processing system, and wherein the performance of the corrective action is associated with the substrate processing of subsequent substrates via the substrate processing system.

9. A non-transitory machine-readable storage medium storing instructions which, when executed cause a processing device to perform operations comprising:
identifying an output image of a substrate defect based on a user sketch of the substrate defect and a text description associated with the substrate defect;
updating the output image based on user input to generate an updated output image; and
causing, based on the updated output image, performance of a corrective action associated with substrate processing via a substrate processing system.

10. The non-transitory machine-readable storage medium of claim 9, wherein the operations further comprise:
identifying the user sketch of the substrate defect;
identifying the text description associated with the substrate defect; and
providing input comprising the user sketch and the text description to a generative trained machine learning model, wherein the output image is associated with output from the generative trained machine learning model.

11. The non-transitory machine-readable storage medium of claim 10, wherein the input further comprises a reference image associated with a reference defect that is similar to the substrate defect.

12. The non-transitory machine-readable storage medium of claim 10, wherein the operations further comprise:
identifying a reference image associated with a reference defect that is similar to the substrate defect;
providing the reference image as corresponding input to a segmentation trained machine learning model;
receiving, from the segmentation trained machine learning model, corresponding output associated with an isolated defect; and
performing, based on the user sketch, resizing and rotating of the isolated defect to generate a matched reference, wherein the input further comprises the matched reference.

13. The non-transitory machine-readable storage medium of claim 9, wherein the operations further comprise:
identifying a reference image associated with a reference defect that is similar to the substrate defect;
providing the reference image as corresponding input to a caption trained machine learning model; and
receiving, from the caption trained machine learning model, output associated with the text description.

14. The non-transitory machine-readable storage medium of claim 9, wherein at least one of:
the user input comprises selection of one or more of a reference image or the output image from a plurality of images;
the causing of the performance of the corrective action comprises one or more of:
processing of a substrate manufacturing part of the substrate processing system; updating manufacturing parameters of the substrate processing system; replacing of the substrate manufacturing part of the substrate processing system; or redesigning the substrate manufacturing part of the substrate processing system; or
the substrate defect is of a substrate processed by the substrate processing system, the performance of the corrective action being associated with the substrate processing of subsequent substrates via the substrate processing system.

15. A system comprising:
memory; and
a processing device coupled to the memory, the processing device to:
identify an output image of a substrate defect based on a user sketch of the substrate defect and a text description associated with the substrate defect;
update the output image based on user input to generate an updated output image; and
cause, based on the updated output image, performance of a corrective action associated with substrate processing via a substrate processing system.

16. The system of claim 15, wherein the processing device is further to:
identify the user sketch of the substrate defect;
identify the text description associated with the substrate defect; and
provide input comprising the user sketch and the text description to a generative trained machine learning model, wherein the output image is associated with output from the generative trained machine learning model.

17. The system of claim 16, wherein the input further comprises a reference image associated with a reference defect that is similar to the substrate defect.

18. The system of claim 16, wherein the processing device is further to:
identify a reference image associated with a reference defect that is similar to the substrate defect;
provide the reference image as corresponding input to a segmentation trained machine learning model;
receive, from the segmentation trained machine learning model, corresponding output associated with an isolated defect; and
perform, based on the user sketch, resizing and rotating of the isolated defect to generate a matched reference, wherein the input further comprises the matched reference.

19. The system of claim 15, wherein the processing device is further to:
identify a reference image associated with a reference defect that is similar to the substrate defect;
provide the reference image as corresponding input to a caption trained machine learning model; and
receive, from the caption trained machine learning model, output associated with the text description.

20. The system of claim 15, wherein at least one of:
the user input comprises selection of one or more of a reference image or the output image from a plurality of images;
to cause the performance of the corrective action, the processing device is to one or more of: process a substrate manufacturing part of the substrate processing system;
update manufacturing parameters of the substrate processing system; replace of the substrate manufacturing part of the substrate processing system; or redesign the substrate manufacturing part of the substrate processing system; or
the substrate defect is of a substrate processed by the substrate processing system, the performance of the corrective action being associated with the substrate processing of subsequent substrates via the substrate processing system.
